(19) United States
(12) Patent Application Publication
(10) Pub. No.: US 2017/0118593 A1
(43) Pub. Date: Apr. 27, 2017

(54) METHOD AND DEVICE FOR POSITION-BASED MESSAGE INFORMATION PARALLEL BROADCASTING

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Hua KANG, Tianjin (CN); Miao XIE, Tianjin (CN); Lulu ZHOU, Tianjin (CN)

(21) Appl. No.: 15/247,736

(22) Filed: Aug. 25, 2016

Related U.S. Application Data
(63) Continuation of application No. PCT/CN2016/086982, filed on Jun. 24, 2016.

(30) Foreign Application Priority Data
Oct. 23, 2015 (CN) 2015106986269

(51) Int. Cl. H04W 4/02; H04L 12/18; H04L 29/08

(52) U.S. Cl. CPC H04W 4/023; H04L 67/18; H04L 12/1813; H04L 67/10

(57) ABSTRACT

Disclosed are a position-based message information parallel broadcasting method and device. The method includes the steps of: receiving current position information of a user, which is submitted by a parallel broadcasting client, wherein the position information comprises user coordinates; according to the submitted current position information, inquiring first message information in a preset range around the user coordinates; and according to preset screening conditions, screening the first message information, and transmitting message information obtained after screening and corresponding message position data to the parallel broadcasting client. According to the present invention, the user can directly see positions of other users when other users leave messages on a map interface, and rapidly and conveniently select and view user messages in the area arousing special attention of the user according to the current position of the user.

### CROSS-REFERENCE TO RELATED APPLICATIONS

This application is a continuation of International Application No. PCT/CN2016/086982, filed on 24 Jun. 2016, which is based upon and claims priority to Chinese Patent Application No. 2015106986269, filed on 23 Oct. 2015, the entire contents of which are incorporated herein by reference.

### TECHNICAL FIELD

The present disclosure relates to the technical field of cloud platform communication, and particularly relates to a position-based message information parallel broadcasting method, apparatus and system.

### BACKGROUND

By operating service software on a computer, a Bulletin Board System (BBS) allows a user to connect the Internet through a terminal program so as to download data or programs, upload data, read news, exchange messages with other users and the like.

In the middle of the 1980s, in the initial development period of the Internet, dialing BBSs which carry out communication on the basis of modem and telephone lines, and a BBS network formed by mutually connecting the BBSs, has appeared. At that time, a network protocol used among BBS sites is mainly Unix to Unix Copy Protocol (UUCP), and contents of the BBS sites are characters or figures consisting of characters.

Current network discussion forums, message boards or bulletin boards and the like can only be divided into different object classes according to the contents of discussions, messages or announcements, or according to administrative region division, message information in different regions are divided into different forums in a character mode.

With regards to subjects related to position-based travel information, by the abovementioned classification mode of messages in the network discussion forums, the user cannot rapidly know the position and environment of discussion contents or rapidly know related message information at the position of the user and its surroundings or visually view discussion contents and message information at positions/areas arousing special attention of the user.

### SUMMARY

In order to solve the technical problem of the prior art that a user cannot rapidly know message information at a specific regional position, the present invention discloses a position-based message information parallel broadcasting method, apparatus and system.

In an aspect of the present disclosure, a position-based message information parallel broadcasting method is provided, which includes: receiving current position information of a user, which is submitted by a parallel broadcasting client, wherein the position information includes user coordinates; according to the submitted current position information, inquiring first message information in a preset range around the user coordinates; and according to preset screening conditions, screening the first message information, and transmitting the screened message information and corresponding message position data to the parallel broadcasting client.

In another aspect of the present disclosure, an electronic device is provided. The electronic device includes: at least one processor, and a memory communicably connected with the at least one processor for storing instructions executable by the at least one processor. Execution of the instructions by the at least one processor causes the at least one processor to: receive current position information of a user, which is submitted by a parallel broadcasting client, wherein the position information includes user coordinates; according to the submitted current position information, inquire first message information in a preset range around the user coordinates; and according to preset screening conditions, screen the first message information, and transmit the screened message information and corresponding message position data to the parallel broadcasting client.

In another aspect of the present disclosure, a non-transitory computer-readable storage medium is provided. The storage medium stores executable instructions that, when executed by an electronic device with a touch-sensitive display, cause the electronic device to: receive current position information of a user, which is submitted by a parallel broadcasting client, wherein the position information includes user coordinates; inquire first message information in a preset range around the user coordinates, according to the submitted current position information; and screen the first message information, and transmit the screened message information, according to preset screening conditions and correspond message position data to the parallel broadcasting client.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of the workflow of an embodiment 1 of the present invention;

FIG. 2 is a schematic diagram of the workflow of an embodiment 2 of the present invention;

FIG. 3 is a schematic diagram of the structure of a parallel broadcasting server of an embodiment 3 of the present invention;

FIG. 4 is a schematic diagram of the structure of a parallel broadcasting client of an embodiment 4 of the present invention;

FIG. 5 is a logic flow chart of a position-based message information parallel broadcasting method of the present invention.

FIG. 6 is a block diagram of a network apparatus which can implement the position-based message information parallel broadcasting method according to the present invention.

### DETAILED DESCRIPTION

Embodiments of the present invention will be described in details below with reference to the accompany drawings, but it should be understood that the scope of the present invention is not limited to the embodiments.

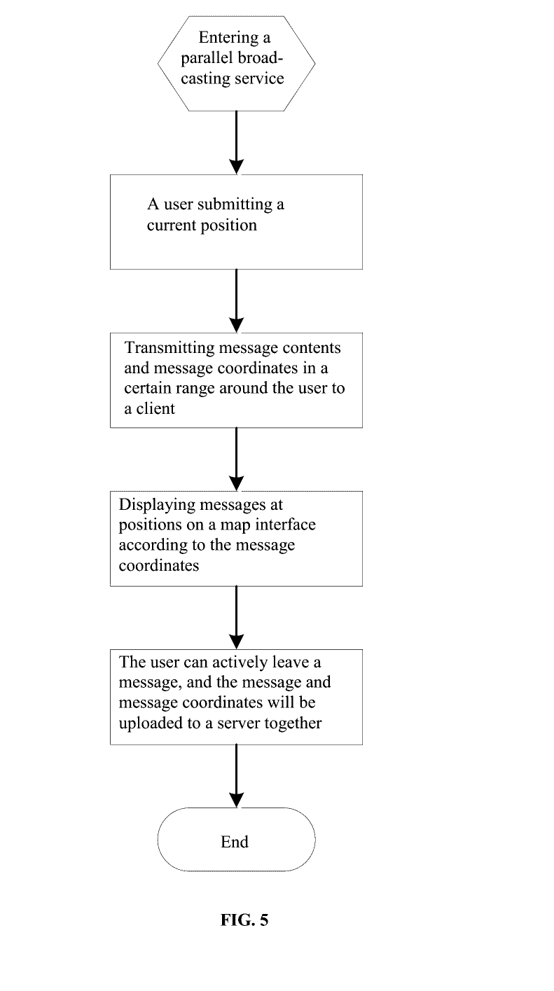

In order to solve the technical problem that in the prior art, a user cannot rapidly know message information at a specific regional position, the present invention discloses a position-based message information parallel broadcasting method, apparatus and system. The logic flow chart of the position-based message information parallel broadcasting method of the present invention, is as shown in FIG. 5.

### Embodiment 1

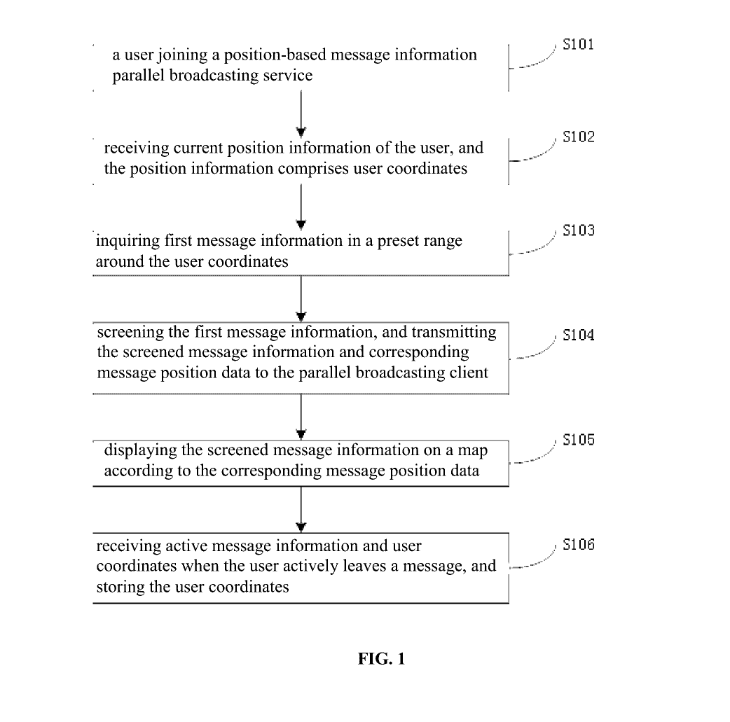

As shown in FIG. 1, the position-based message information parallel broadcasting method of the present invention includes the following steps:
S101: a user joining a position-based message information parallel broadcasting service.
S102: receiving current position information of the user, and the current position information is submitted by a parallel broadcasting client. The position information includes user coordinates; and the user submitting the successfully-acquired current position information to a parallel broadcasting server.
S103: according to the submitted current position information, inquiring first message information in a preset range around the user coordinates. For example, the parallel broadcasting server can inquire all message information in a range of 5 km around the user according to the position submitted by the user.
S104: according to preset screening conditions, screening the first message information, and transmitting message information obtained after screening and corresponding message position data to the parallel broadcasting client. Namely, effective message information in the message information in the range of 5 km around the user and the corresponding message position data are transmitted to the client.
S105: the client displaying the message information obtained after screening at certain points on a map according to the corresponding message position data; after acquiring the transmitted peripheral message information, the client displays the message information at the corresponding certain points on the map according to the message position data.
S106: the server receiving active message information and user coordinates when the user actively leaves a message, which are sent by the parallel broadcasting client, and storing the user coordinates when the user actively leaves the message as the message position data of the active message information.

At step S106, when the user actively leaves the message, the message information and a user position when the user leaves the message are simultaneously submitted to the server, the user position when the user leaves the message is saved at the server as the message position data of the message information so as to facilitate the calling and use of the server at any time.

According to the position-based message information parallel broadcasting method of the present invention, the problem that the user cannot rapidly know the position of the user or message information in an area arousing special attention of the user is solved, and the user can directly see positions of other users when other users leave messages on a map interface, and rapidly and conveniently select and view user messages in the area arousing special attention of the user according to the current position of the user. According to the present invention, the user can actively leave the message, and the message information and position information when the user leaves the message are sent to the server so that the server can carry out storage and call the information at any time, and therefore the interaction efficiency of the message information is improved.

### Embodiment 2

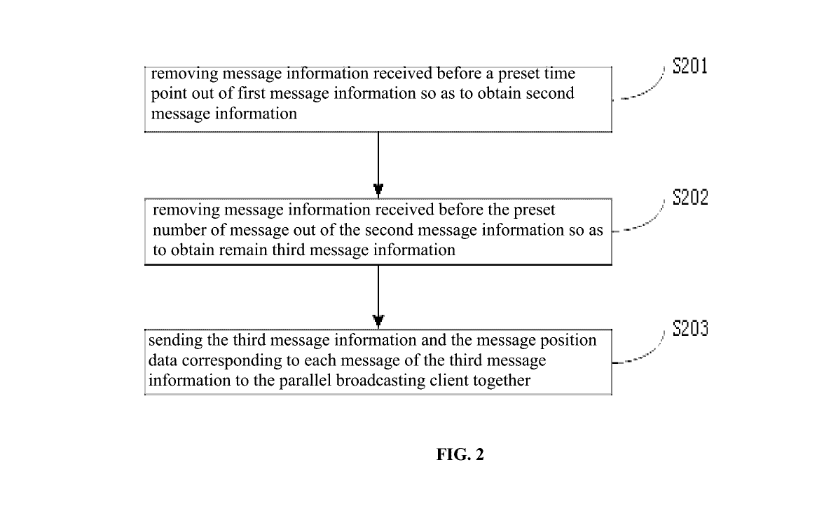

As shown in FIG. 2, the step S104 in the embodiment 1 is further defined and illustrated, and includes the following steps:
S201: removing message information before a preset time point out of first message information so as to obtain second message information left. Particularly, for example, according to the position coordinates of the user, acquiring all messages in the range of 5 km around the user; and for all the acquired messages in the range of 5 km around the user, making a judgment according to message time, and removing messages left 24 hours ago so as to obtain message information left within the latest 24 hours.
S202: removing message information before the preset number of message out of the second message information so as to obtain third message information left. Particularly, after removing the messages left 25 hours ago, counting messages left, and if the message number is greater than 20, removing messages before the latest 20 message and then only retaining these latest 20 messages.
S203: sending the third message information and the message position data corresponding to each message of the third message information to the parallel broadcasting client together.

At step S203, the finally retained messages which are left within the latest 24 hours and are not more than 20 in quantity, and the position data of each message of the message information are transmitted to the client together.

The embodiment 2 is a further limitation to the embodiment 1, and has all the beneficial technical effects of the embodiment 1, which are not repeated herein.

### Embodiment 3

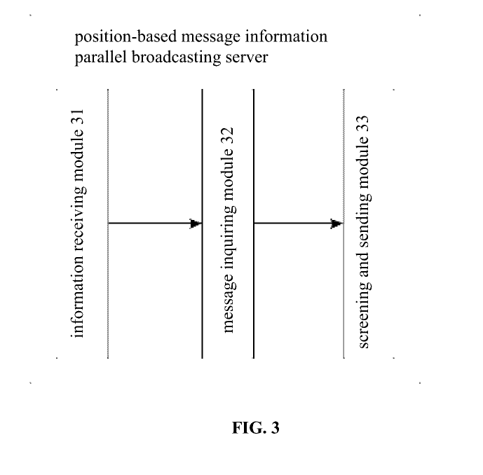

As shown in FIG. 3, the present invention further discloses a position-based message information parallel broadcasting server, which includes an information receiving module 31, a message inquiring module 32 and a screening and sending module 33.

The information receiving module 31 is used for receiving current position information of a user, which is submitted by a parallel broadcasting client, wherein the position information includes user coordinates.

The message inquiring module 32 is used for inquiring first message information in a preset range around the user coordinates according to the submitted current position information.

The screening and sending module 33 is used for screening the first message information according to preset screening conditions and transmitting message information obtained after screening and corresponding message position data to the parallel broadcasting client.

Preferably, the information receiving module 31 is also used for receiving active message information and user coordinates when the user actively leaves a message, which are sent by the parallel broadcasting client, and storing the user coordinates when the user actively leaves the message as the message position data of the active message information.

Preferably, the screening and sending module 33 is particularly used for: removing message information received before a preset time point out of the first message information so as to obtain remain message information as second message information; removing message information before the preset number of message out of the second message information so as to obtain remain message information as third message information; and sending the third message information and the message position data corresponding to each message of the third message information to the parallel broadcasting client together.

### Embodiment 4

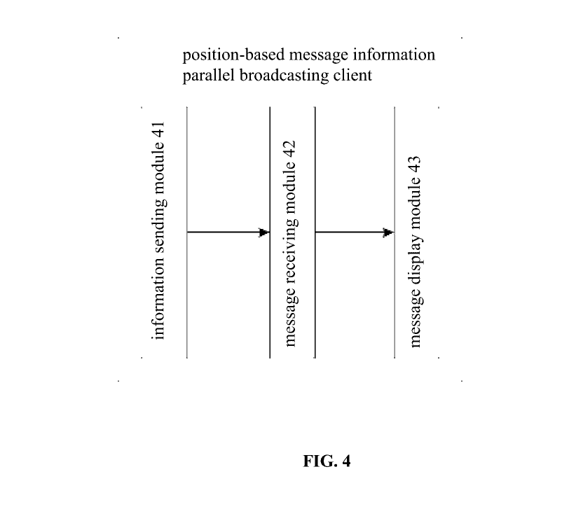

As shown in FIG. 4, the present invention further discloses a position-based message information parallel broadcasting client, which includes: an information sending module 41, which is used for submitting current position information of a user to a parallel broadcasting server so that the parallel broadcasting server can inquire first message information in a preset range around user coordinates according to the submitted current position information, wherein the position information includes the user coordinates; a message receiving module 42, which is used for receiving message information obtained after the parallel broadcasting server screens the first message information according to preset screening conditions, and corresponding message position data; and a message display module 43, which is used for displaying the screened message information at certain points on a map according to the corresponding message position data.

Preferably, the information sending module 41 is also used for sending active message information and user coordinates when the user actively leaves a message to the parallel broadcasting server so that the parallel broadcasting server can store the user coordinates as the message position data of the active message information.

### Embodiment 5

The present invention further discloses a position-based message information parallel broadcasting system, which includes: the position-based message information parallel broadcasting server in the embodiment 3 and the position-based message information parallel broadcasting client in the embodiment 4.

The present invention can have various different forms of embodiments, and taking FIG. 1 to FIG. 5 as examples, the technical solution of the present invention is illustrated above with reference to the accompany drawings, but it does not mean that embodiments applied by the present invention can only be limited to the specific flow or embodiment structure. Those skilled in the art should understand that the specific implementation solutions provided above are only some examples in various preferred applications, and any embodiments embodying the claims of the present invention shall fall in the protection scope of the technical scheme of the present invention.

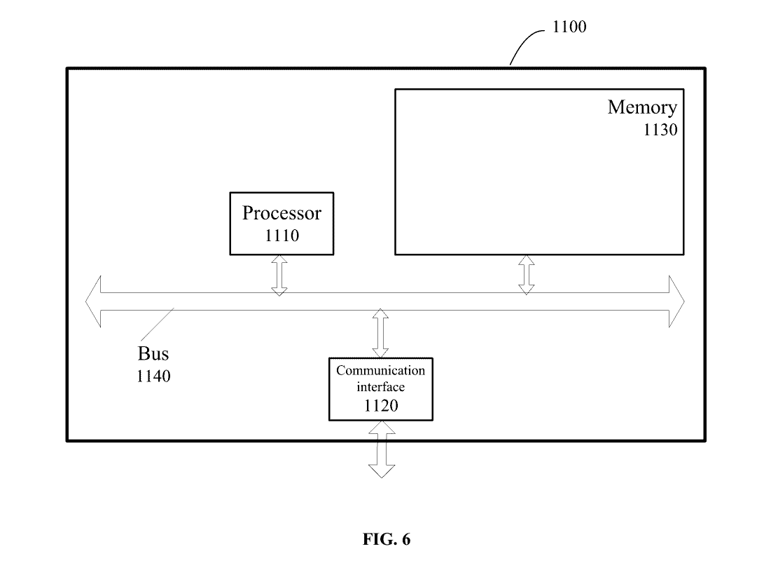

FIG. 6 is a block diagram of a network apparatus which can implement the position-based message information parallel broadcasting method according to the present invention. The network device 1100 may be a host server, a personal computer (PC), or a portable computer or terminal and the like with computing power. The specific embodiments of the present invention do not limit concrete implementation of computing nodes.

The network device 1100 includes a processor 1110, a communications interface 1120, a memory (memory array) 1130 and a bus 1140, wherein the processor 1110, the communications interface 1120 and the memory 1130 communicate with one another through the bus 1140.

The communications interface 1120 is used for communicating with a network element, wherein the network element includes, for example, a virtual machine management center, shared storage and the like.

The processor 1110 is used for executing programs. The processor 1110 may be a central processing unit (CPU), or an ASIC (Application Specific Integrated Circuit), or one or more integrated circuits configured to implement the embodiments of the present invention.

The memory 1130 is used for storing files. The memory 1130 may include a high-speed RAM memory, and may also include a non-volatile memory, for example, at least one disk memory. The memory 1130 also can be a memory array. The memory 1130 may also be partitioned into blocks, and the blocks can be combined into a virtual volume according to a certain rule.

In a possible embodiment, the above-mentioned programs may be program codes including computer operating instructions that can causes the processor to: receive current position information of a user, which is submitted by a parallel broadcasting client, wherein the position information includes user coordinates; according to the submitted current position information, inquire first message information in a preset range around the user coordinates; and according to preset screening conditions, screen the first message information, and transmit the screened message information and corresponding message position data to the parallel broadcasting client.

In a possible embodiment, execution of the instructions by the at least one processor further causes the at least one processor to: receive active message information and user coordinates which are sent by the parallel broadcasting client when the user actively leaves a message, and store the user coordinates when the user actively leaves the message as the message position data of the active message information.

In a possible embodiment, during the execution of screening the first message information according to the preset screening conditions and transmitting the screened message information and the corresponding message position data to the parallel broadcasting client, the at least one processor is further caused to: remove message information that is received before a preset time point out of first message information so as to obtain remain information as second message information; remove message information that is received before a preset number of messages out of the second message information so as to obtain remain information as third message information; and send the third message information and the message position data corresponding to each message of the third message information to the parallel broadcasting client together.

It will be appreciated by those skilled in the art that the embodiments of the present invention can provide a method, a system, or a computer program product. Therefore, the present invention can adopt a form of full-hardware embodiments, full-software embodiments, or embodiments with combination of hardware and software. Moreover, the present invention can adopt a form of the computer program product implemented on one or more computer-available storage media (including but not limited to a disk memory and an optical memory, etc.) containing computer-available program codes.

Finally, it should be noted that the above only refers to the preferred embodiments of the present invention and not intended to limit the present invention, and although the present invention is illustrated in details with reference to the embodiments, those skilled in the art still can make modification to the technical scheme recorded in each embodiment, or make equivalent replacements to part of technical features in the embodiments. Any modifications, equivalent replacements, improvements and the like within the spirit and principle of the present invention shall fall in the protection scope of the present invention.

What is claimed is:

1. A position-based message information parallel broadcasting method, adapted to be used in a server, comprising:
receiving current position information of a user, which is submitted by a parallel broadcasting client, wherein the position information comprises user coordinates;
according to the submitted current position information, inquiring first message information in a preset range around the user coordinates; and
according to preset screening conditions, screening the first message information, and transmitting the screened message information and corresponding message position data to the parallel broadcasting client.

2. The method according to claim 1, further comprising:
receiving active message information and user coordinates which are sent by the parallel broadcasting client, when the user actively leaves a message, and storing the user coordinates when the user actively leaves the message as the message position data of the active message information.

3. The method according to claim 1, wherein the step of screening the first message information according to the preset screening conditions and transmitting the screened message information and the corresponding message position data to the parallel broadcasting client comprises:
removing message information that is received before a preset time point out of first message information so as to obtain remain information as second message information;
removing message information that is received before a preset number of messages out of the second message information so as to obtain remain information as third message information; and
sending the third message information and the message position data corresponding to each message of the third message information to the parallel broadcasting client together.

4. An electronic device, comprising:
at least one processor; and
a memory communicably connected with the at least one processor for storing instructions executable by the at least one processor, wherein execution of the instructions by the at least one processor causes the at least one processor to:
receive current position information of a user, which is submitted by a parallel broadcasting client, wherein the position information comprises user coordinates;
according to the submitted current position information, inquire first message information in a preset range around the user coordinates; and
according to preset screening conditions, screen the first message information, and transmit the screened message information and corresponding message position data to the parallel broadcasting client.

5. The electronic device according to claim 4, wherein execution of the instructions by the at least one processor further causes the at least one processor to:
receive active message information and user coordinates which are sent by the parallel broadcasting client when the user actively leaves a message, and store the user coordinates when the user actively leaves the message as the message position data of the active message information.

6. The electronic device according to claim 4, wherein during the execution of screening the first message information according to the preset screening conditions and transmitting the screened message information and the corresponding message position data to the parallel broadcasting client, the at least one processor is further caused to:
remove message information that is received before a preset time point out of first message information so as to obtain remain information as second message information;
remove message information that is received before a preset number of messages out of the second message information so as to obtain remain information as third message information; and
send the third message information and the message position data corresponding to each message of the third message information to the parallel broadcasting client together.

7. A non-transitory computer-readable storage medium storing executable instructions that, when executed by an electronic device with a touch-sensitive display, cause the electronic device to:
receive current position information of a user, which is submitted by a parallel broadcasting client, wherein the position information comprises user coordinates;
inquire first message information in a preset range around the user coordinates, according to the submitted current position information; and
screen the first message information, and transmit the screened message information, according to preset screening conditions and correspond message position data to the parallel broadcasting client.

8. The non-transitory computer-readable storage medium according to claim 7, wherein execution of the instructions further causes the electronic device to:
receive active message information and user coordinates which are sent by the parallel broadcasting client when the user actively leaves a message, and store the user coordinates when the user actively leaves the message as the message position data of the active message information.

9. The non-transitory computer-readable storage medium according to claim 7, wherein during the execution of screening the first message information according to the preset screening conditions and transmitting the screened message information and the corresponding message position data to the parallel broadcasting client, the electronic device is further caused to:
remove message information that is received before a preset time point out of first message information so as to obtain remain information as second message information;
remove message information that is received before a preset number of messages out of the second message information so as to obtain remain information as third message information; and
send the third message information and the message position data corresponding to each message of the third message information to the parallel broadcasting client together.
